(19) United States
(12) Patent Application Publication
(10) Pub. No.: US 2019/0204059 A1
(43) Pub. Date: Jul. 4, 2019

(54) POSITION-SENSING SYSTEM

(71) Applicant: NATIONAL SYNCHROTRON RADIATION RESEARCH CENTER, Hsinchu (TW)

(72) Inventor: HUAI-SAN WANG, HSINCHU (TW)

(21) Appl. No.: 15/861,193

(22) Filed: Jan. 3, 2018

(51) Int. Cl. G01B 5/14; G01B 5/004

(52) U.S. Cl. CPC G01B 5/14; G01B 5/004

(57) ABSTRACT

A position-sensing system includes a first measuring device and a second measuring device. The first measuring device, disposed on a right portion of a first object, is configured to extend by a first length in response to a first movement of the right portion of the first object with respect to a second object. The second measuring device, disposed on a left portion of the first object, is configured to extend by a second length in response to a second movement of the left portion of the first object with respect to the second object, wherein a distance between the right portion of the first object and the second object is a function of a length difference between the first length and the second length.

### TECHNICAL FIELD

The present disclosure relates to a position-sensing system, and more particularly, to a position-sensing system for operating two objects moving with respect to each other.

### DISCUSSION OF THE BACKGROUND

Limit switches are provided on motor driven valves to allow the valves to be remotely opened and closed. Typically, the limit switches are used in situations where separate signals are needed to define the points at which the motor should be deactivated as the gate nears its open and closed positions. Currently, many laboratories and industries use two drives for driving an object. When the two drives do not move simultaneously, the object will rotate.

This Discussion of the Background section is for background information only. The statements in this Discussion of the Background are not an admission that the subject matter disclosed in this section constitutes a prior art to the present disclosure, and no portion of this section may be used as an admission that any portion of this application, including this Discussion of the Background section, constitutes prior art to the present disclosure.

### SUMMARY

One aspect of the present disclosure provides a position-sensing system. The position-sensing system includes a first measuring device and a second measuring device. The first measuring device, disposed on a right portion of a first object, is configured to extend by a first length in response to a first movement of the right portion of the first object with respect to a second object. The second measuring device, disposed on a left portion of the first object, is configured to extend by a second length in response to a second movement of the left portion of the first object with respect to the second object, wherein a distance between the right portion of the first object and the second object is a function of a length difference between the first length and the second length.

In some embodiments, the distance between the right portion of the first object and the second object is a function of the length difference and a width of the first object.

In some embodiments, a relationship among the distance, the length difference and the width is expressed below:

$${OD}^{′} = OD - W \times sin ( \frac{L 1 - L 2}{W} )$$

where OD′ represents the distance, OD represents an optimal distance between the first object and the second object, W represents the width of the first object, L1 represents the first length, and L2 represents the second length.

Another aspect of the present disclosure provides a position-sensing system. The position-sensing system includes a first measuring device, a second measuring device and an intermediate device. The first measuring device, disposed on a right portion of a first object, is configured to extend by a first length in response to a first movement of the right portion of the first object with respect to a second object. The second measuring device, disposed on a left portion of the first object, is configured to extend by a second length in response to a second movement of the left portion of the first object with respect to the second object, wherein the second length is different from the first length. The intermediate device includes a controller and a driving device. The controller is configured to calculate an adjustment distance based on the first length, the second length and a width of the first object. The driving device is configured to move the first object by the adjustment distance and not stop the first object when a distance between the right portion of the first object and the second object reaches an optimal distance, wherein the optimal distance is a point for which, if the first length were equal to the second length, then the driving device would normally stop moving the first object when the distance reached the point.

In some embodiments, the controller is configured to trigger an alarm signal when a length difference between the first length and the second length reaches a threshold difference.

In some embodiments, the first measuring device extends by the first length and the second measuring device extends by the second length during the same period.

In some embodiments, the intermediate device further includes a first port, wherein the intermediate device is configured to, at the first port, receive, from the first measuring device, a first data indicating the first length, and, at the first port, receive, from the second measuring device, a second data indicating the second length.

In some embodiments, the intermediate device further includes a decoder configured to provide the controller with a first decoded data and a second decoded data by decoding the first data and the second data.

In some embodiments, the intermediate device further includes a storage device configured to store the first decoded data and the second decoded data.

In some embodiments, the first port includes an EnDat interface.

In some embodiments, the intermediate device further includes a second port, wherein the intermediate device is configured to provide the first data and the second data to a single-hoard computer independent of the position-sensing system at the second port.

In some embodiments, the second port includes a serial peripheral interface bus (SPI).

In some embodiments, the first port and the controller are packaged in a Field Programmable Gate Array (FPGA).

Another aspect of the present disclosure provides a position-sensing system. The position-sensing system includes an intermediate device. The intermediate device includes a controller and a driving device. The controller is configured to calculate an adjustment distance based on an angle, greater than zero, between a first object and a second object. The driving device is configured to move the first object farther by the adjustment distance and not stop the first object when a distance between a right portion of the first object and the second object reaches an optimal distance, wherein the optimal distance is a point for which, if the first length were equal to the second length, then the driving device would normally stop moving the first object when the distance reached the point.

In some embodiments, the controller calculates the adjustment distance based on the following expression:

AD=W×sin θ

where AD represents the adjustment distance, W represents the width of the first object, and θ represents the angle.

In some embodiments, the position-sensing system further includes a first measuring device and a second measuring device. The first measuring device, disposed on the right portion of the first object, is configured to extend by a first length in response to a first movement of the right portion of the first object with respect to the second object. The second measuring device, disposed on a left portion of the first object, is configured to extend by a second length in response to a to second movement of the left portion of the first object with respect to the second object, wherein the controller is configured to calculate the angle based on the following equation:

$$θ = \frac{L 1 - L 2}{W}$$

wherein θ represents the angle, L1 represents the first length L2 represents the second length, and W represents the width of the first object.

In some embodiments, the controller is configured to trigger an alarm signal when a length difference between the first length and the second length reaches a threshold difference.

In some embodiments, the first measuring device extends by the first length and the second measuring device extends by the second length during the same period.

In some embodiments, the intermediate device further includes a first port, wherein the intermediate device is configured to, at the first port, receive, from the first measuring device, a first data indicating the first length, and, at the first port, receive, from the second measuring device, a second data indicating the second length.

In some embodiments, the intermediate device further includes a second port, wherein the intermediate device is configured to provide the first data and the second data to a single-board computer independent of the position-sensing system at the second port.

In the position-sensing system of the present disclosure, during operations of the first object and the second object, even if the first object is not parallel to the second object, there is no need to stop the operations of the first object and the second object in order to adjust a distance used for triggering the alarm signal. An operating system adopting the position-sensing system is relatively efficient. Moreover, since information of the first length and the second length is continually fed back to the controller, the controller is able to dynamically adjust the distance used to trigger the alarm signal, and therefore the controller is able to dynamically adjust the distance between the right portion of the first object and the second object.

The foregoing has outlined rather broadly the features and technical advantages of the present disclosure in order that the detailed description of the disclosure that follows may be better understood. Additional features and advantages of the disclosure will be described hereinafter, and form the subject of the claims of the disclosure. It should be appreciated by those skilled in the art that the conception and specific embodiment disclosed may be readily utilized as a basis for modifying or designing other structures or processes for carrying out the same purposes of the present disclosure. It should also be realized by those skilled in the art that such equivalent constructions do not depart from the spirit and scope of the disclosure as set forth in the appended claims.

### BRIEF DESCRIPTION OF THE DRAWINGS

A more complete understanding of the present disclosure may be derived by referring to the detailed description and claims. The disclosure should also be understood to be coupled to the figures reference numbers, which refer to similar elements throughout the description, and:

FIG. 1 is a schematic diagram illustrating using a comparative limit switch having a length to determine whether a distance between objects equals an optimal distance.

FIG. 2 is a schematic diagram illustrating a scenario in which one object is not parallel to the other object.

FIG. 3 is a schematic diagram illustrating the comparative limit switch having a decreased length.

FIG. 4 is a schematic diagram illustrating using the comparative limit switch having the decreased length to determine whether a distance between the objects equals the optimal distance.

FIG. 5 is a schematic diagram of a position-sensing system including a first measuring device and a second measuring device, in accordance with some embodiments of the present disclosure.

FIG. 6 is a schematic diagram illustrating using the first measuring device and the second measuring device shown in FIG. 5 to detect a distance between a first object and a second object, in accordance with some embodiments of the present disclosure.

FIG. 7 is a schematic diagram illustrating an operation of the first measuring device and the second measuring device shown in FIG. 5 in a scenario in which the first object is not parallel to the second object, and the first object moves with respect to the second object, in accordance with some embodiments of the present disclosure.

FIG. 8 is a flow diagram of a method operating a position-sensing system, in accordance with some embodiments of the present disclosure.

### DETAILED DESCRIPTION

Embodiments, or examples, of the disclosure illustrated in the drawings are now described using specific language. It shall be understood that no limitation of the scope of the disclosure is hereby intended. Any alteration or modification of the described embodiments, and any further applications of principles described in this document, are to be considered as normally occurring to one of ordinary skill in the art to which the disclosure relates. Reference numerals may be repeated throughout the embodiments, but this does not necessarily mean that feature(s) of one embodiment apply to another embodiment, even if they share the same reference numeral.

It shall be understood that, although the terms first, second, third, etc. may be used herein to describe various elements, or components, these elements or components are not limited by these terms. Rather, these terms are merely used to distinguish one element or component from another element or component. Thus, a first element or component discussed below could be termed a second element or component without departing from the teachings of the present inventive concept.

The terminology used herein is for the purpose of describing particular example embodiments only and is not intended to be limiting to the present inventive concept. As used herein, the singular forms “a,” “an” and “the” are intended to include the plural forms as well, unless the context clearly indicates otherwise. It shall be further understood that the terms “comprises” and “comprising,” when used in this specification, point out the presence of stated features, integers, steps, operations, elements, or components, but do not preclude the presence or addition of one or more other features, integers, steps, operations, elements, components, or groups thereof.

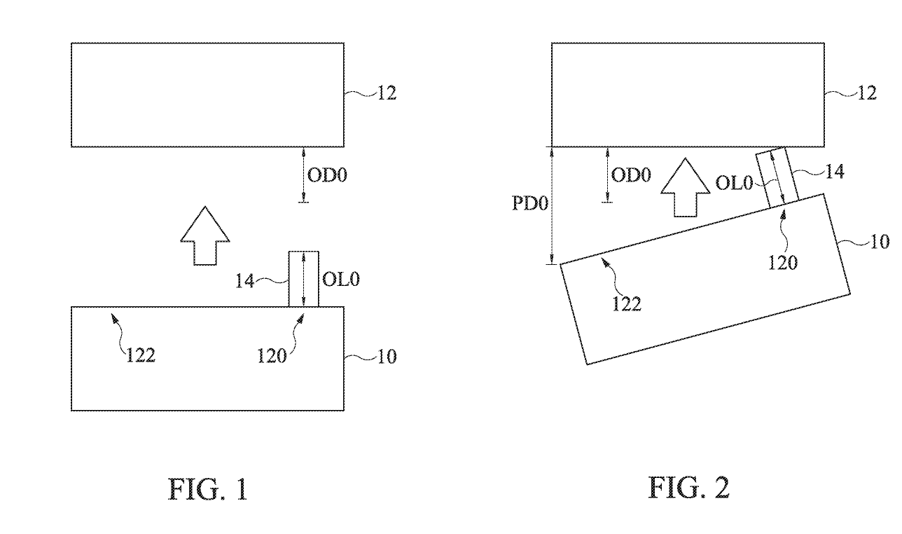

FIG. 1 is a schematic diagram illustrating using a comparative limit switch 14 having a length OL0 to determine whether a distance between objects 10 and 12 equals an optimal distance OD0. Referring to FIG. 1, to better operate the objects 10 and 12, an operator typically designs the optimal distance OD0.

The limit switch 14, disposed on the object 10, functions to trigger an alarm signal when a distance between the objects 10 and 12 becomes equal to the optimal distance OD0. In further detail, the length OL0 of the limit switch 14 is adjusted to be equal to the optimal distance OD0. As such, when the limit switch 14 is in contact with the object 12, the distance equals the optimal distance OD0.

In the example shown in FIG. 1, the limit switch 14 is disposed on the right portion 120 of the object 10. As such, when the limit switch 14 is in contact with the object 12, a distance between the right portion 120 of the object 10 and the object 12 equals the optimal distance OD0. Therefore, the limit switch 14 triggers the alarm signal. As such, the length OL0 of the limit switch 14 can be deemed as a distance used for triggering the alarm signal.

In operation, in an initial state, the objects 10 and 12 are arranged to be spaced apart by a distance greater than the optimal distance OD0. Subsequently, the object 10 moves with respect to the object 12. If, during the process of the movement, the object 10 remains parallel to the object 12, then when the limit switch 14 is in contact with the object 12, not only the distance but also a distance between a left portion 122 of the object 10 and the object 12 equal the optimal distance OD0.

However, in the process of the movement, the object 10, for example, may be slightly rotated. In such case, the object 10 does not remain parallel to the object 12, as shown in FIG. 2.

FIG. 2 is a schematic diagram illustrating a scenario in which the object 10 is not parallel to the object 12. Referring to FIG. 2, the right portion 120 of the object 10 is closer to the object 12 than the left portion 122 of the object 10. As such, when the limit switch 14, disposed on the right portion 120 of the object 10, is in contact with the object 12, a distance PD0 between the left portion 122 of the object 10 and the object 12 may be significantly greater than the optimal distance OD0.

In order to bring the distance PD0 closer to the optimal distance OD0, the operator might adjust the length OL0 of the limit switch 14. Therefore, the operator must stop operation of the objects 10 and 12, and detach the limit switch 14 from the object 10. After detachment, the operator adjusts the length OL0 of the limit switch 14 based on the distance PD0.

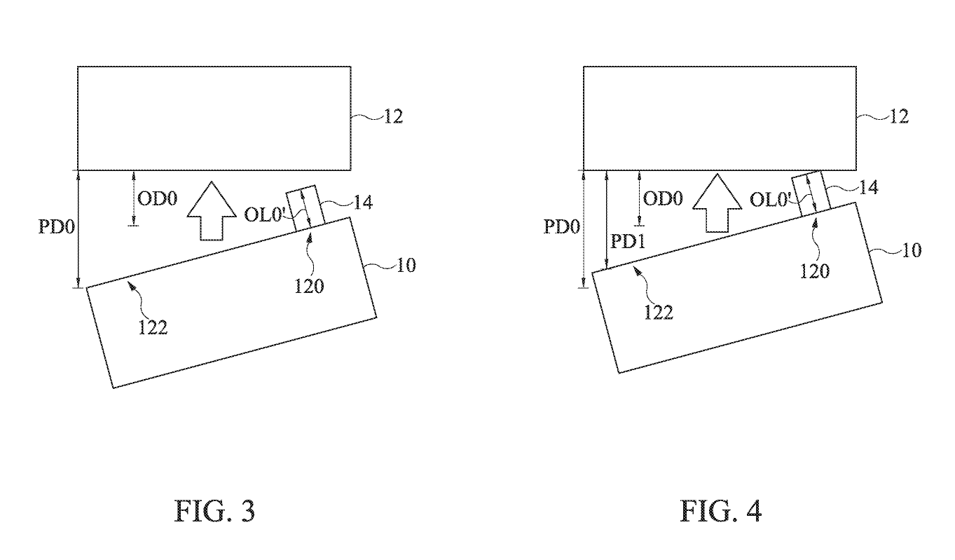

FIG. 3 is a schematic diagram illustrating the comparative limit switch 14 having a decreased length OL0′. Referring to FIG. 3, the operator disposes the limit switch 14 having the decreased length OL0′ back on the object 10. As shown in FIG. 3, the limit switch 14 having the decreased length OL0′ is not in contact with the object 12. As such, the object 10 is able to move an additional distance with respect to the object 12.

FIG. 4 is a schematic diagram illustrating using the comparative limit switch 14 having the decreased length OL0′ to determine whether a distance between the objects 10 and 12 equals the optimal distance OD0. Referring to FIG. 4, after moving the object 10 the additional distance with respect to the object 12, the limit switch 14 having the decreased length OL0′ is in contact with the object 12 again. This time, a distance between the left portion 122 of the object 10 and the object 12 is decreased from the distance PD1 to a distance PD1. The distance PD1 is closer to the optimal distance OD0 than the distance PD0. As a result, the objects 10 and 12 exhibit better operating performance in such scenario than in the previous scenario, in which the left portion of the object 10 and the object 12 are spaced apart by the relatively long distance PD0.

In a system adopting the comparative limit switch 14, as previously mentioned, the length OL0 of the limit switch 14 is adjusted based on a distance between the left portion 122 of the object 12 and the object 10. In the process of detaching and disposing the limit switch 14, the objects 10 and 12 may be inadvertently moved or rotated, and therefore the distance may be changed unknowingly. Consequently, the length OL0 of the limit switch 14 cannot be adjusted precisely.

The objects 10 and 12 are typically arranged in a room. It is generally not possible or not appropriate for the operator to be present in the room while the objects 10 and 12 are in operation. Therefore, during the movement of the object 10, the operator is unable to monitor whether the object 10 is remains parallel with respect to the object 12 until an alarm signal is triggered in response to contact between the limit switch 14 and the object 12. When the alarm signal is triggered, the operator goes into the room and is able to recognize the non-parallel situation, if it exists, and adjusts the length OL0 of the limit switch 14. As a result of the limitations of such system, the system is unable to dynamically adjust a distance, i.e., the length of the limit switch 14, used for triggering the alarm signal. Therefore, operation of the system is inefficient.

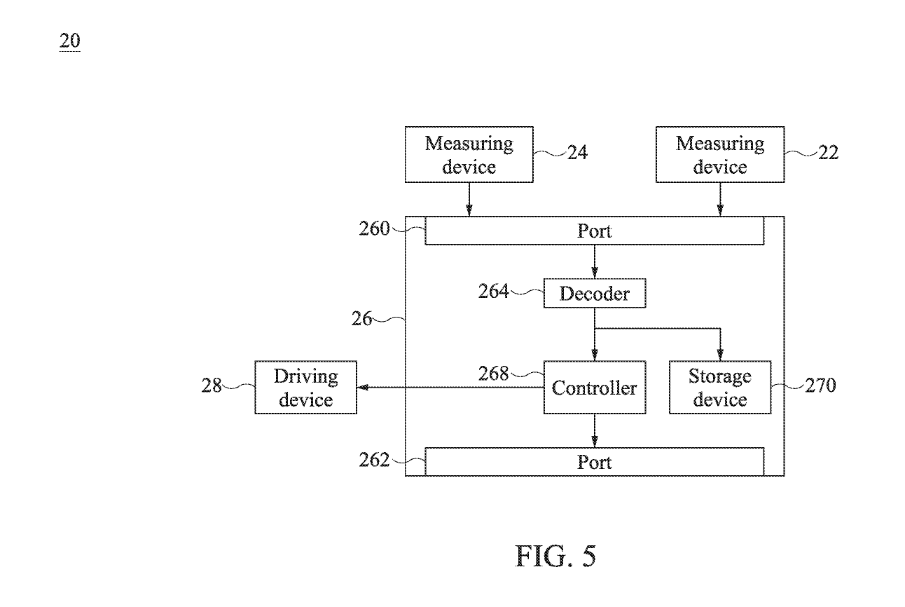

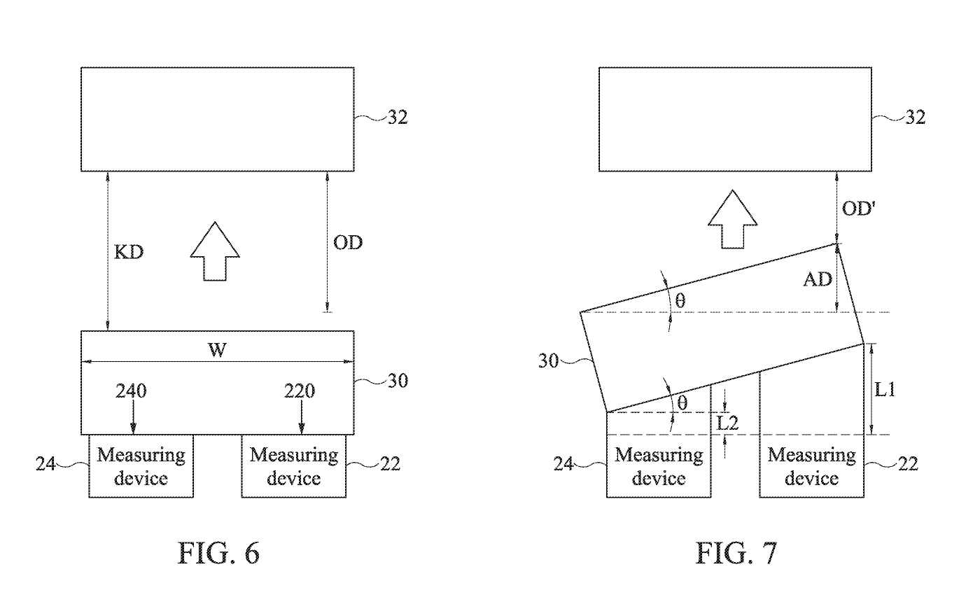

FIG. 5 is a schematic diagram of a position-sensing system 20 including a first measuring device 22 and a second measuring device 24, in accordance with some embodiments of the present disclosure. FIG. 6 is a schematic diagram illustrating using the first measuring device 22 and the second measuring device 24 shown in FIG. 5 to detect a distance between a first object 30 and a second object 32, in accordance with some embodiments of the present disclosure. Referring to FIG. 6, as with the objects 10 and 12, to better operate the objects 30 and 32, there is an optimal distance OD therebetween.

The position-sensing system 20 functions to detect movement of the first object 30, and controls the movement of the first object 30 based on the detection result, as described in detail below.

The position-sensing system 20 includes a driving device 28 and an intermediate device 26 in addition to the first measuring device 22 and the second measuring device 24.

The first measuring device 22, disposed on a right portion 220 of a first object 30, functions to extend in response to a first movement of the right portion 220 of the first object 30 with respect to the second object 32. In an embodiment, a sampling frequency of the first measuring device 22 includes, but is not limited to, about 10 hertz (Hz). In an embodiment, the first measuring device 22 includes an encoder. The encoder includes an encoder data (EnDat) encoder, an NRZ encoder, or a bidirectional serial synchronous (BiSS) encoder.

The second measuring device 24, disposed on a left portion 240 of the first object 30, functions to extend in response to a second movement of the left portion 240 of the first object 30 with respect to the second object 32. When the first object 30 is rotated such that the first object 30 is not parallel to the second object 32, the first movement is not equal to the second movement. In contrast, if the first object 30 remains parallel to the second object 32 while the first object 30 moves, the first movement is equal to the second movement. In an embodiment, a sampling frequency of the second measuring device 24 includes, but is not limited to, about 10 hertz (Hz). In an embodiment, the second measuring device 24 includes an encoder. The encoder includes an EnDat encoder, an NRZ encoder, or a BiSS encoder.

The intermediate device 26 functions to determine how to control the movement of the first object 30 based on the extensions of the first measuring device 22 and the second measuring device 24.

The driving device 28 functions to drive the first object 30 based on the determination from the intermediate device 26.

The intermediate device 26 includes a controller 268, a decoder 264, a storage device 270, a first port 260 and a second port 262.

The controller 268 functions to determine how to control the movement of the first object 30 based on the extensions of the first measuring device 22 and the second measuring device 24. In some embodiments, the controller 104 includes a central processing unit (CPU), a microprocessor or a microcontroller.

In operation, the controller 268 obtains information on an initial distance KD between the first object 30 and the second object 32 in an initial state (i.e., before the first object 30 has moved), information on the optimal distance OD, and information on a width W of the first object 30.

By subtracting the optimal distance OD from the initial distance KD, the controller 268 calculates a moving distance by which the first object 30 moves with respect to the second object 32.

In a circumstance that the first object 30 remains parallel to the second object 32 while the first object 30 moves, when one of the first measuring device 22 and the second measuring device 24 extends by a length equal to the moving distance, the controller 268 determines that each of a distance between the right portion 220 of the first object 30 and the second object 32 and a distance between the left portion 240 of the first object 30 and the second object 32 equals the optimal distance OD. Subsequently, the controller 268 triggers the alarm signal.

However, as discussed in the example shown in FIG. 2, the first object 30 may be rotated, such that the first object 30 does not remain parallel to the second object 32 while the first object 30 moves, as shown in FIG. 7.

FIG. 7 is a schematic diagram illustrating an operation of the first measuring device 22 and the second measuring device 24 shown in FIG. 5 in a scenario in which the first object 30 is not parallel to the second object 32, and the first object 30 moves with respect to the second object 32, in accordance with some embodiments of the present disclosure. Referring to FIG. 7, because of the rotation of the first object 30, the right portion 220 of the first object 30 is closer to the second object 32 than the left portion 240 of the first object 30. As such, when an extension length of the first measuring device 22 equals the moving distance, an extension length of the second measuring device 24 does not equal the moving distance, which means that a distance between the left portion 240 of the first object 30 and the second object 32 is still significantly greater than the optimal distance OD.

In the present disclosure, with the controller 268, the first measuring device 22 and the second measuring device 24, there is no need to stop operations of the first object 30 and the second object 32 to adjust a distance used for triggering the alarm signal, as described in detail below.

As previously mentioned, in some cases, while the first object 30 is being moved, the first object 30 is rotated. In operation, the right portion 220 of the first object 30 moves a first moving distance (hereinafter, a first movement) with respect to the second object 32, and the left portion 240 of the first object 30 moves a second moving distance (hereinafter called, a second movement) with respect to the second object 32.

Correspondingly, the first measuring device 22, disposed on the right portion 220 of the first object 30, extends by a first length L1 in response to the first movement. The second measuring device 24, disposed on the left portion 240 of the first object 30, extends by a second length L2 different from the first length L1 in response to the second movement. It should be noted that for illustration a shape of the first measuring device 22 is exaggerated, such that a left portion and right portion of the first measuring device 22 looks like that they does not extend by the same length. However, in the present disclosure, the left portion and the right portion of the first measuring device 22 substantially extend by the same first length L1. The similar reasons are also applied to the second measuring device 24. In an embodiment, the first measuring device 22 extends by the first length L1 and the second measuring device 24 extends by the second length L2 during the same period.

The controller 268 calculates an adjustment distance AD based on the first length L1, the second length L2 and the width W of the first object 30. In further detail, first, the controller 268 calculates an angle between the first object 30 and the second object 32 based on the following equation (1), which is a formula for calculating an arc length:

$$θ = \frac{L 1 - L 2}{W} \qquad ( 1 )$$

Since the first length L1 is different from the second length L2, the angle θ is non-zero. Subsequently, the controller 268 calculates the adjustment distance AD based on the following equation (2):

AD=W×sin θ (2)

Where AD represents the adjustment distance, W represents the width of the first object 30, and θ represents the angle.

After the adjustment distance AD is obtained, the driving device 28 moves the first object 30 farther by the adjustment distance AD and does not stop the first object 30 when a distance between the right portion 220 of the first object 30 and the second object 32 equals the optimal distance OD.

The optimal distance OD is a point for which, if the first length L1 were equal to the second length L2, then the driving device 28 would normally stop moving the first object 30 when the distance reached the point. Moreover, when the first length L1 were equal to the second length L2, the angle θ would equal to zero. In such case, the optimal distance OD is also a point for which, if the angle θ were equal to zero, then the driving device 28 would normally stop moving the first object 30 when the distance reached the point.

Since the optimal distance OD is known and the adjustment distance AD is calculated, a distance between the right portion 220 of the first object 30 and the second object 32 can be calculated based on the following equation:

OD′=OD−AD

Where OD′ represents the distance between the right portion 220 of the first object 30 and the second object 32, and AD represents the adjustment distance.

In summary, the distance OD′ between the right portion 220 of the first object 30 and the second object 32 is a function of a length difference between the first length L1 and the second length L2. In further detail, the distance OD′ between the right portion 220 of the first object 30 and the second object 32 is a function of the length difference and the width W of the first object 30.

A distance used for triggering the alarm signal is dynamically adjusted to the distance OD′. That is, the controller does not trigger the alarm signal until the distance between the right portion 220 of the first object 30 and the second object 32 becomes equal to the distance OD′.

In an embodiment, the controller 268 functions to trigger an alarm signal when the length difference between the first length L1 and the second length L2 reaches a threshold difference.

In the position-sensing system 20 of the present disclosure, during operations of the first object 30 and the second object 32, even if the first object 30 is not parallel to the second object 32, there is no need to stop the operations of the first object 30 and the second object 32 to adjust a distance used for triggering the alarm signal. An operating system adopting the position-sensing system 20 is relatively efficient. Moreover, since information of the first length L1 and the second length L2 is continually fed back to the controller 268, the controller 268 is able to dynamically adjust the distance used for triggering the alarm signal, and the controller 268 is therefore able to dynamically adjust the distance between the right portion 220 of the first object 30 and the second object 32. As a result, a distance between the first object 30 and the second object 32 can still be optimized relatively well even though the first object 30 is not parallel to the second object 32.

The intermediate device 26 functions to, at the first port 260, receive, from the first measuring device 22, a first data indicating the first length L1, and, at the first port 260, receive, from the second measuring device 24, a second data indicating the second length L2. In an embodiment, the first port 260 includes an EnDat interface. In an embodiment, the first port 260 and the controller 268 are packaged in a Field Programmable Gate Array (FPGA). Moreover, the intermediate device 26 functions to provide the first data and the second data to a server independent of the position-sensing system 20 at the second port 262. In an embodiment, the second port 262 includes a serial peripheral interface bus (SPI). In some embodiments, the server includes a single board computer, a personal computer, a blade server, a laptop or a work station. The server includes a web server for providing the first data and the second data to the Internet for remote monitoring. An operating system (OS) of the server may include Linux, Windows, CentOS, Debian or MacOS. A web server of the server device may include an Apache HTTP server or an Internet Information Server (IIS), A database of the server may include MySQL, Microsoft SQL Server, or MongoDB. In an embodiment, the server backs up the first data and the second data via a cloud storage solution. The cloud storage solution may include Amazon Web Service Simple Storage Service (AWS S3) or Hinet hicloud S3.

The decoder 264 functions to provide the controller 268 with a first decoded data and a second decoded data by decoding the first data and the second data. In some embodiments, the decoder 264 includes an EnDat decoder, an NRZ decoder or a BiSS decoder.

The storage device 270 functions to store the first decoded data and the second decoded data. In some embodiments, the storage device 270 includes a hard drive, a solid state disk, a programmable read-only memory (PROM), an erasable programmable read-only memory (EPROM), or an electrically erasable programmable read-only memory (EEPROM).

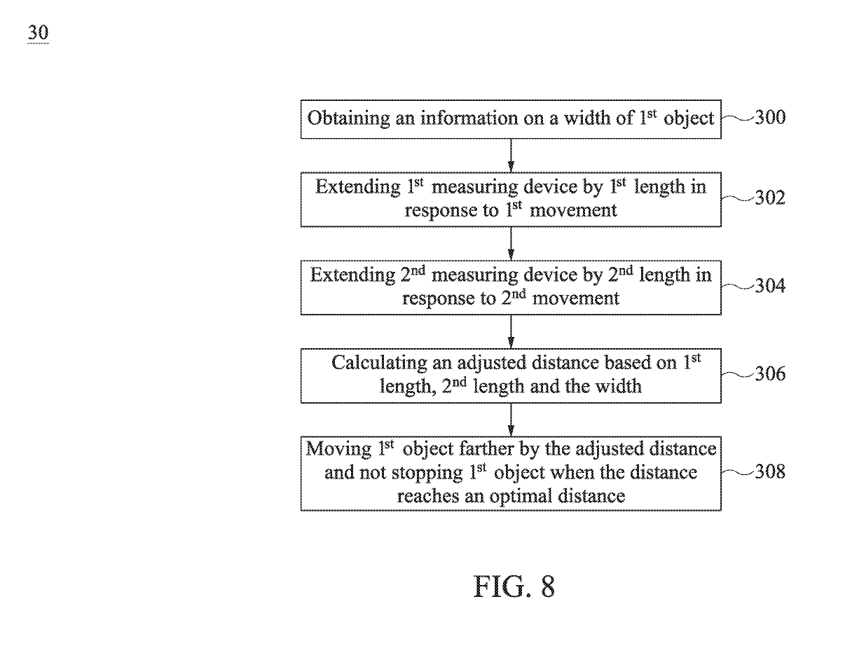

FIG. 8 is a flow diagram of a method 30 for operating a position-sensing system, in accordance with some embodiments of the present disclosure. Referring to FIG. 8, the method 30 includes operations 300, 302, 304, 306 and 308.

The method 30 begins with operation 300, in which information on a width of a first object is obtained.

The method 30 continues with operation 302, in which a first measuring device, disposed on a right portion of the first object, extends by a first length in response to a first movement of the right portion of the first object with respect to a second object.

The method 30 continues with operation 304, in which a second measuring device, disposed on a left portion of the first object by a second length in response to a second movement of the left portion of the first object with respect to the second object.

The method 30 proceeds to operation 306, in which an adjustment distance is calculated based on the first length, the second length and the width.

The method 30 proceeds to operation 308, in which the first object is moved farther by the adjustment distance and is not stopped when the distance reaches an optimal distance.

In the position-sensing system 20 of the present disclosure, during the operations of the first object 30 and the second object 32, even if the first object 30 is not parallel to the second object 32, there is no need to stop the operations of the first object 30 and the second object to adjust a distance used for triggering the alarm signal. An operating system adopting the position-sensing system 20 is relatively efficient. Moreover, since information of the first length L1 and the second length L2 is continually fed back to the controller 268, the controller 268 is able to dynamically adjust the distance used for triggering the alarm signal, and the controller 268 is therefore able to dynamically adjust the distance between the right portion 220 of the first object 30 and the second object 32.

One aspect of the present disclosure provides a position-sensing system. The position-sensing system includes a first measuring device and a second measuring device. The first measuring device, disposed on a right portion of a first object, is configured to extend by a first length in response to a first movement of the right portion of the first object with respect to a second object. The second measuring device, disposed on a left portion of the first object, is configured to extend by a second length in response to a second movement of the left portion of the first object with respect to the second object, wherein a distance between the right portion of the first object and the second object is a function of a length difference between the first length and the second length.

Another aspect of the present disclosure provides a position-sensing system. The position-sensing system includes a first measuring device, a second measuring device and an intermediate device. The first measuring device, disposed on a right portion of a first object, is configured to extend by a first length in response to a first movement of the right portion of the first object with respect to a second object. The second measuring device, disposed on a left portion of the first object, is configured to extend by a second length in response to a second movement of the left portion of the first object with respect to the second object, wherein the second length is different from the first length. The intermediate device includes a controller and a driving device. The controller is configured to calculate an adjustment distance based on the first length, the second length and a width of the first object. The driving device is configured to move the first object farther by the adjustment distance without stopping the first object when a distance between the right portion of the first object and the second object reaches an optimal distance, wherein the optimal distance is a point for which, if the first length were equal to the second length, then the driving device would normally stop moving the first object when the distance reached the point.

Another aspect of the present disclosure provides a position-sensing system. The position-sensing system includes an intermediate device. The intermediate device includes a controller and a driving device. The controller is configured to calculate an adjustment distance based on an angle, which is greater than zero, between a first object and a second object. The driving device is configured to move the first object farther by the adjustment distance without stopping the first object when a distance between a right portion of the first object and the second object reaches an optimal distance, wherein the optimal distance is a point for which, if angle were equal to zero, then the driving device would normally stop moving the first object when the distance reached the point.

Although the present disclosure and its advantages have been described in detail, it should be understood that various changes, substitutions and alterations can be made herein without departing from the spirit and scope of the disclosure as defined by the appended claims. For example, many of the processes discussed above can be implemented in different methodologies and replaced by other processes, or a combination thereof.

Moreover, the scope of the present application is not intended to be limited to the particular embodiments of the process, machine, manufacture, composition of matter, means, methods and steps described in the specification. As one of ordinary skill in the art will readily appreciate from the disclosure of the present disclosure, processes, machines, manufacture, compositions of matter, means, methods, or steps, presently existing or later to be developed, that perform substantially the same function or achieve substantially the same result as the corresponding embodiments described herein may be utilized according to the present disclosure. Accordingly, the appended claims are intended to include within their scope such processes, machines, manufacture, compositions of matter, means, methods, or steps.

What is claimed is:

1. A position-sensing system, comprising:
a first measuring device, disposed on a right portion of a first object, configured to extend by a first length in response to a first movement of the right portion of the first object with respect to a second object; and
a second measuring device, disposed on a left portion of the first object, configured to extend by a second length in response to a second movement of the left portion of the first object with respect to the second object,
wherein a distance between the right portion of the first object and the second object is a function of a length difference between the first length and the second length.

2. The position-sensing system of claim 1, wherein the distance between the right portion of the first object and the second object is a function of the length difference and a width of the first object.

3. The position-sensing system of claim 1, wherein a relationship among the distance, the length difference and the width is expressed below:
$${OD}^{′} = OD - W \times sin ( \frac{L 1 - L 2}{W} )$$
where OD′ represents the distance, OD represents an optimal distance between the first object and the second object, W represents the width of the first object, L1 represents the first length, and L2 represents the second length.

4. A position-sensing system, comprising:
a first measuring device, disposed on a right portion of a first object, configured to extend by a first length in response to a first movement of the right portion of the first object with respect to a second object;
a second measuring device, disposed on a left portion of the first object, configured to extend by a second length in response to a second movement of the left portion of the first object with respect to the second object, wherein the second length is different from the first length; and
an intermediate device including:
a controller configured to calculate an adjustment distance based on the first length, the second length and a width of the first object; and
a driving device configured to move the first object farther by the adjustment distance without stopping the first object when a distance between the right portion of the first object and the second object reaches an optimal distance, wherein the optimal distance is a point for which, if the first length were equal to the second length, then the driving device would normally stop moving the first object when the distance reached the point.

5. The position-sensing system of claim 4, wherein the controller is configured to trigger an alarm signal when a length difference between the first length and the second length reaches a threshold difference.

6. The position-sensing system of claim 4, wherein the first measuring device extends by the first length and the second measuring device extends by the second length during the same period.

7. The position-sensing system of claim 4, wherein the intermediate device further includes a first port, wherein the intermediate device is configured to, at the first port, receive, from the first measuring device, a first data indicating the first length, and, at the first port, receive, from the second measuring device, a second data indicating the second length.

8. The position-sensing system claim 4, wherein the intermediate device further includes:
a decoder configured to provide the controller with a first decoded data and a second decoded data by decoding the first data and the second data.

9. The position-sensing system claim 8, wherein the intermediate device further includes:
a storage device configured to store the first decoded data and the second decoded data.

10. The position-sensing system of claim 1, wherein the first port includes an EnDat interface.

11. The position-sensing system of claim 7, wherein the intermediate device further includes a second port, wherein the intermediate device is configured to provide the first data and the second data to a single-board computer independent of the position-sensing system at the second port.

12. The position-sensing system of claim 11, wherein the second port includes a serial peripheral interface bus (SPI).

13. The position-sensing system of claim 7, wherein the first port and the controller are packaged in a Field Programmable Gate Array (FPGA).

14. A position-sensing system, comprising:
an intermediate device including:
a controller configured to calculate an adjustment distance based on an angle, which is greater than zero, between a first object and a second object; and
a driving device configured to move the first object farther by the adjustment distance without stopping the first object when a distance between a right portion of the first object and the second object reaches an optimal distance, wherein the optimal distance is a point for which, if angle were equal to zero, then the driving device would normally stop moving the first object when the distance reached the point.

15. The position-sensing system of claim 14, wherein the controller calculates the adjustment distance based on the following expression:
AD=W×sin θ
where AD represents the adjustment distance, W represents the width of the first object, and θ represents the angle.

16. The position-sensing system of claim 15, further comprising:
a first measuring device, disposed on the right portion of the first object, configured to extend by a first length in response to a first movement of the right portion of the first object with respect to the second object; and
a second measuring device, disposed on a left portion of the first object, configured to extend by a second length in response to a second movement of the left portion of the first object with respect to the second object,
wherein the controller is configured to calculate the angle based on the following equation:
$$θ = \frac{L 1 - L 2}{W}$$
wherein θ represents the angle, L1 represents the first length, L2 represents the second length, and W represents the width of the first object.

17. The position-sensing system of claim 16, wherein the controller is configured to trigger an alarm signal when a length difference between the first length and the second length reaches a threshold difference.

18. The position-sensing system of claim 16, wherein the first measuring device extends by the first length and the second measuring device extends by the second length during the same period.

19. The position-sensing system of claim 16, wherein the intermediate device further includes a first port, wherein the intermediate device is configured to, at the first port, receive, from the first measuring device, a first data indicating the first length, and, at the first port, receive, from the second measuring device, a second data indicating the second length.

20. The position-sensing system of claim 19, wherein the intermediate device further includes a second port, wherein the intermediate device is configured to provide the first data and the second data to a single-board computer independent of the position-sensing system at the second port.
